(19) United States
(12) Patent Application Publication
(10) Pub. No.: US 2019/0005476 A1
(43) Pub. Date: Jan. 3, 2019

(54) DUAL-SCREEN SALE TERMINAL

(71) Applicant: PAX COMPUTER TECHNOLOGY (SHENZHEN) CO., LTD., Shenzhen, Guangdong (CN)

(72) Inventors: Shaowen LUO, Shenzhen (CN); Chenghe YANG, Shenzhen (CN); Jigui LI, Shenzhen (CN)

(21) Appl. No.: 15/744,104

(22) PCT Filed: Aug. 3, 2017
(86) PCT No.: PCT/CN2017/095857

§ 371 Date: Jan. 12, 2018

(30) Foreign Application Priority Data
Jun. 30, 2017 (CN) 201720791562.1

(51) Int. Cl. G06Q 20/20; G06K 7/08

(52) U.S. Cl. CPC G06Q 20/20; G06K 7/087

(57) ABSTRACT

The present application provides a dual-screen sale terminal which includes a housing, a mainboard mounted inside the housing, and a first display and a second display that are mounted on the housing. The first display is electrically connected with the mainboard, a front side of the housing defines an arc-shaped opening, the housing comprises a base, a frame bending and extending forwardly from an upper end of the base, and a bracket inclinedly extending downwardly from a front end of the frame, the main board is mounted inside the base, the first display is mounted on the bracket, and the second display is mounted on the upper end of the base.

### TECHNICAL FIELD

The present application pertains to the technical field of dual-screen sale terminals, and more particularly to a dual-screen sale terminal.

### BACKGROUND

Customers often want to see products' details when they buy, consume, or pay for the products, and thus a display screen to display for the customers is required. When merchants confirm consumption conditions of the customers, they also need to check consumption details via a screen. A current sale terminal is generally equipped with a display screen for the merchants to check; however, when shown for the customer, the sale terminal is required to be rotated, the use is inconvenient. Thus, the current sale terminal is often externally connected to another display screen, and a support rod is used to support the externally connected display screen, thereby forming a dual-screen sale terminal. However, this dual-screen sale terminal occupies relatively large space.

### SUMMARY

It is an object of the present application to provide a dual-screen sale terminal, so as to solve problem of large occupied space of the sale terminal in the prior art.

In order to achieve the above object, the present application adopts the following technical solution: a dual-screen sale terminal is provided, which comprises a housing and a mainboard mounted inside the housing, and further comprises a first display and a second display that are mounted on the housing; the first display is electrically connected with the mainboard, a front side of the housing defines an arc-shaped opening, the housing comprises: a base, a frame bending and extending forwardly from an upper end of the base, and a bracket inclinedly extending downwardly from a front end of the frame; and the main board is mounted in the base, the first display is mounted on the bracket, and the second display is mounted on the upper end of the base.

Further, the second display is a smart tablet electronic device.

Further, the second display comprises a display screen body and a support base supporting the display screen body.

Further, the support base comprises a fixed base mounted on the base and a support block supporting the display screen body, and the support block is pivotally connected to the fixed base.

Further, the fixed base is U-shaped, the fixed base comprises a bottom plate and two support plates formed by respectively bending two ends of the bottom plate, a bottom of the support block defines slots allowing the two support plates to be inserted therein, and the support base further comprises an pivotal axle allowing the two support plates to be pivotally connected to the support block.

Further, a rear side of a interface region between the base and the frame defines a mounting recess, and the fixed base is mounted to a bottom of the mounting recess.

Further, a lower part of the base comprises an accommodation chamber, a printer is mounted inside the accommodation chamber, and the printer is electrically connected with the mainboard.

Further, the dual-screen sale terminal further comprises a card swiping device, the card swiping device is mounted at an upper side of the frame, and the card swiping device is electrically connected with the mainboard.

Further, the dual-screen sale terminal further comprises a support supporting the card swiping machine, the support is mounted at a connection portion between the frame and the bracket, a data insertion pin configured to connect with the card swiping machine is mounted in the support, the data insertion pin is electrically connected with the mainboard, and a bottom of the card swiping device is provided with a gold finger configured to connect with the data insertion pin.

Further, the card swiping machine comprises: a casing, a circuit board mounted inside the casing, a magnetic head configured to read information of magnetic strip cards, a card reader configured to read information of chip cards, and a card support configured to locate cards. The card support defines therein a card slot allowing the card to be inserted therein, the card support is mounted inside the casing, the magnetic head is electrically connected with the circuit board, the card reader is mounted on the card support, the magnetic head is disposed on the card support, a side of the casing defines a first opening allowing the card to be inserted into the card slot, the gold finger is electrically connected with the circuit board, and a bottom of the casing defines a second opening exposing the gold finger.

The duel-screen sale terminal provided by the present application have at least the following advantages: compared with the prior art, in the present application, the housing is formed by the base, the frame, and the bracket, the front side of the housing defines the arc-shaped opening, the first display is mounted on the bracket, and the second display is mounted on the upper end of the base. It can be ensured that the housing is stably supported on the table, and it can also be convenient for persons in front of and behind the casing to observe contents displayed on the first display and the second display, moreover, the arrangement of the structure can reduce the occupied space, thereby facilitating use.

### BRIEF DESCRIPTION OF THE DRAWINGS

In order to more clearly illustrate the technical solution in embodiments of the present application, the following drawings, which are to be used in the description of the embodiments or the prior art, will be briefly described. It will be apparent that the drawings described in the following description are merely some embodiments of the present application. Other drawings may be obtained by those skilled in the art without paying creative labor.

FIG. 1 is a first structural schematic view of a dual-screen sale terminal provided by a first embodiment of the present application;

FIG. 2 is a second structural schematic view of the dual-screen sale terminal provided by the first embodiment of the present application;

FIG. 3 is a structural schematic view of the dual-screen sale terminal of FIG. 1 without a card swiping device;

FIG. 4 is a structural schematic view of the dual-screen sale terminal of FIG. 3 viewed from another angle;

FIG. 5 is a structural schematic view of a second screen of FIG. 4;

FIG. 6 is a structural schematic view of a base and a support of the dual-screen sale terminal of FIG. 1;

FIG. 7 is a structural schematic view of a card swiping device of the dual-screen sale terminal of FIG. 1;

FIG. 8 is a second structural schematic view of the card swiping device of FIG. 7;

FIG. 9 is a first exploded structural schematic view of the card swiping device of FIG. 7;

FIG. 10 is a second exploded structural schematic view of the card swiping device of FIG. 7;

FIG. 11 is a first inner structural schematic view of the card swiping device of the card swiping device of FIG. 10;

FIG. 12 is a second inner structural schematic view of the card swiping device of the card swiping device of FIG. 10; and

FIG. 13 is a structural schematic view of a dual-screen sale terminal provided by a second embodiment of the present application.

In the figures, the following numeral references are used:

100: Dual-screen sale machine; 10: Housing; 101: Arc-shaped opening; 102: Mounting recess; 11: Base; 111: Accommodation chamber; 112: Cover plate; 113: Arc: shaped strip; 114: Heat dissipation hole; 12: Frame; 13: Bracket; 18: Data communication interface; 21: First display; 22: Support; 221: Accommodation recess; 222: Data plug; 23: Printer; 30: Second display; 31: Display screen body; 32: Support base; 33: Fixed base; 331: Bottom plate; 332: Support plate; 34: Support block; 341: Slot; 50: Card swiping device; 51: Casing; 511: Upper cover; 512: Bottom cover; 52: Positioning head; 521: Slit; 522: Notch; 523: Guide slot; 53: Circuit board; 531: Gold finger; 532: Data interface; 54: Card support; 541: Card slot; 542: Support plate; 543: Ribs; 55: Card reader; 561: Resilient piece; 56: Magnetic head; 562: Flexible circuit board; and 58: Display screen.

### DETAILED DESCRIPTION OF THE EMBODIMENTS

In order to make the technical problems to be solved, the technical solutions, and advantages of the present application more clear, the present application will be further described in detail with reference to the accompanying drawings and embodiments. It should be understood that the embodiments described herein are only used to explain the present invention but are not intended to limit the present application.

It should be noted that when an element is referred to as being “fixed” or “arranged” on another element, it can be directly on another element or be indirectly on another element. When an element is referred to as being “connected” to another element, it can be directly connected to another element or indirectly connected to another element.

In the description of the present application, it should be understood that terms “length”, “width”, “thickness”, “above”, “beneath”, “front”, “rear”, “left”, “right”, “vertical”, “horizontal”, “top”, “bottom”, “inner””, and the like are based on the orientation or the positional relationship shown in the drawings, which is for the convenience of describing the present application and the simplified description, rather than indicating or implying that the device or element referred to must have a particular orientation or be constructed and operated in the particular orientation, and therefore these orientation or positional relationship should not be explained as limiting the present invention.

In addition, terms like “first” and “second” are only used for the purpose of description, and will in no way be interpreted as indication or hint of relative importance or implicitly indicate the number of the referred technical features. Thus, the features prefixed by “first” and “second” will explicitly or implicitly represent that one or more of the referred technical features are included. In the description of the present application, “multiple” or “a plurality of” refers to the number of two or more than two, except for clear and particular restriction.

In the description of the present application, it should be noted that, unless otherwise particularly stipulated or defined, terms “mounted”, “connected”, and “fixed” should be broadly interpreted as, for example, fixed connection, detachable connection, or permanent connection; mechanical connection or electrical connection; direct connected or indirect connection via media, or communication between inner parts of two elements or mutual action between two elements. For those skilled in the art, the specific meanings of the above terms in the present application may be understood based on specific situations.

### Embodiment 1

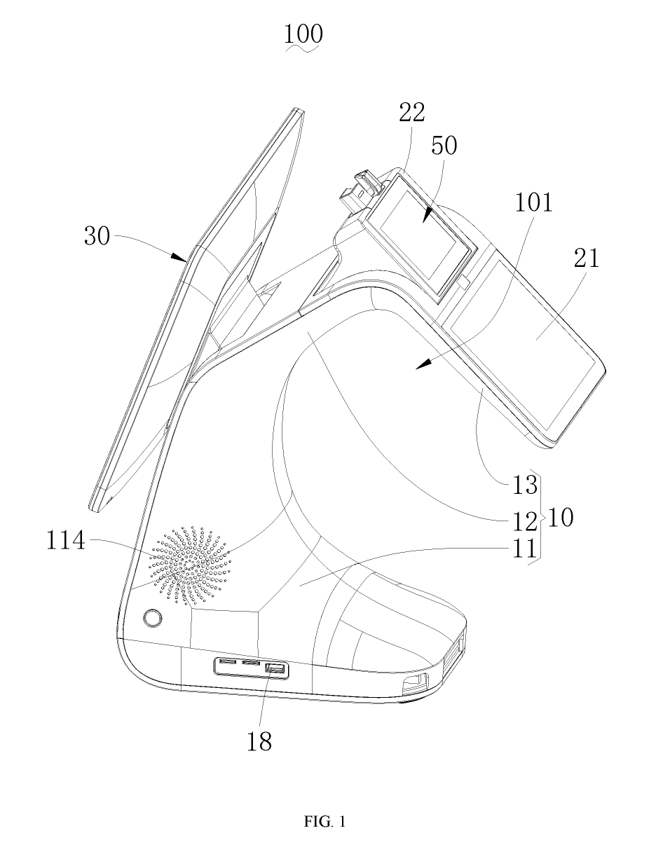

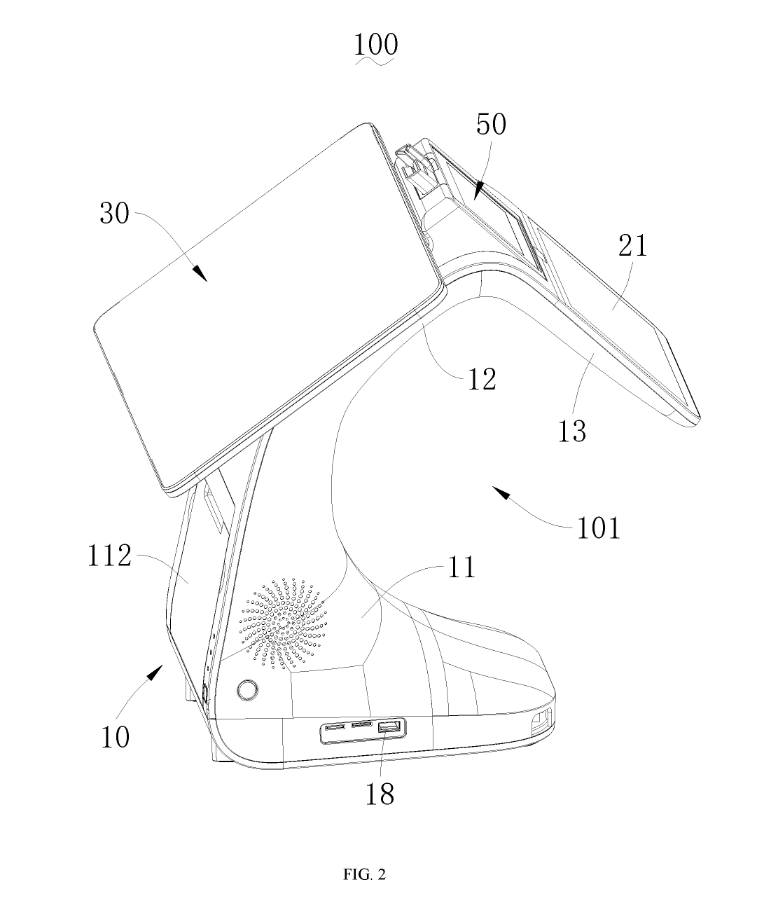

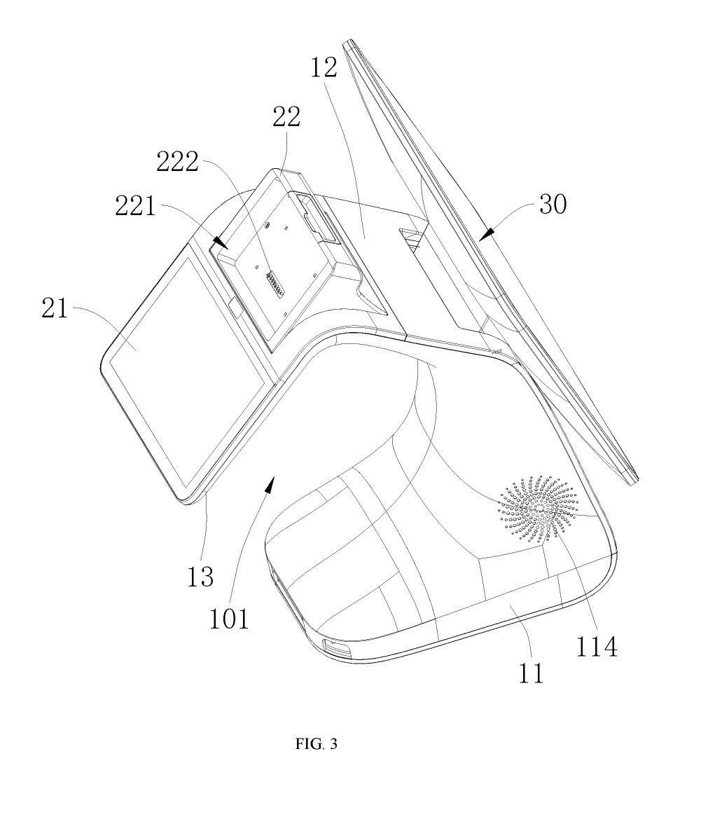

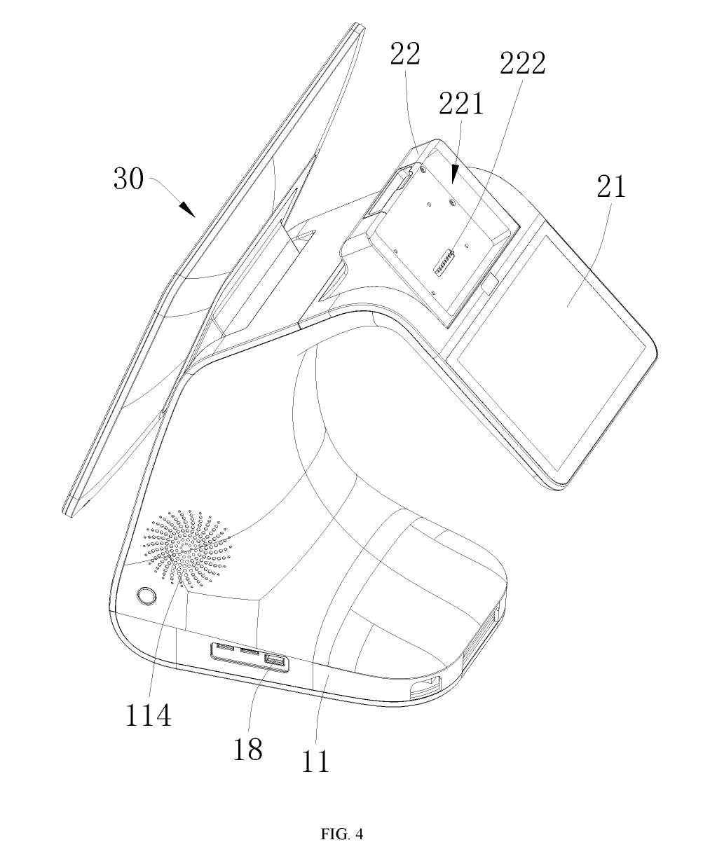

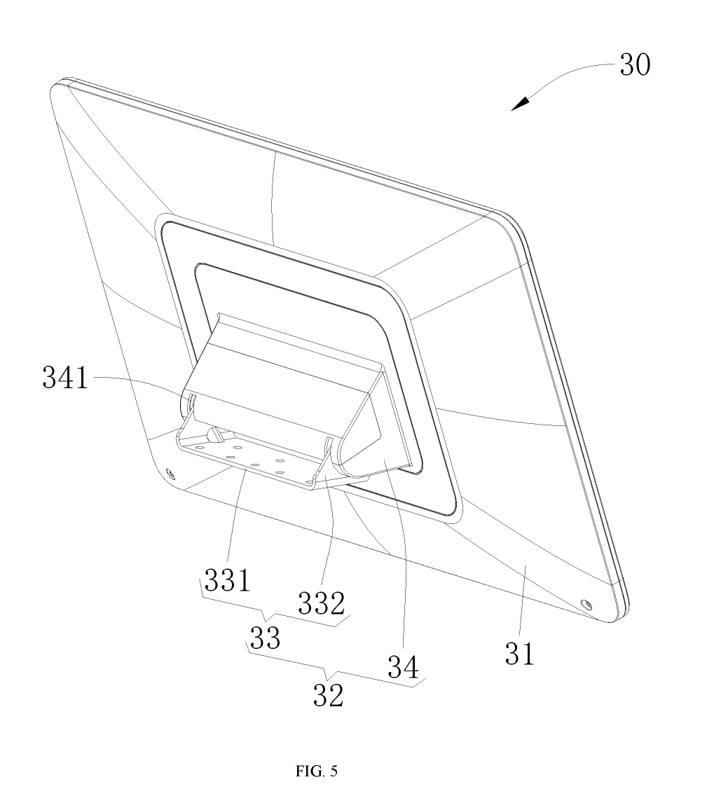

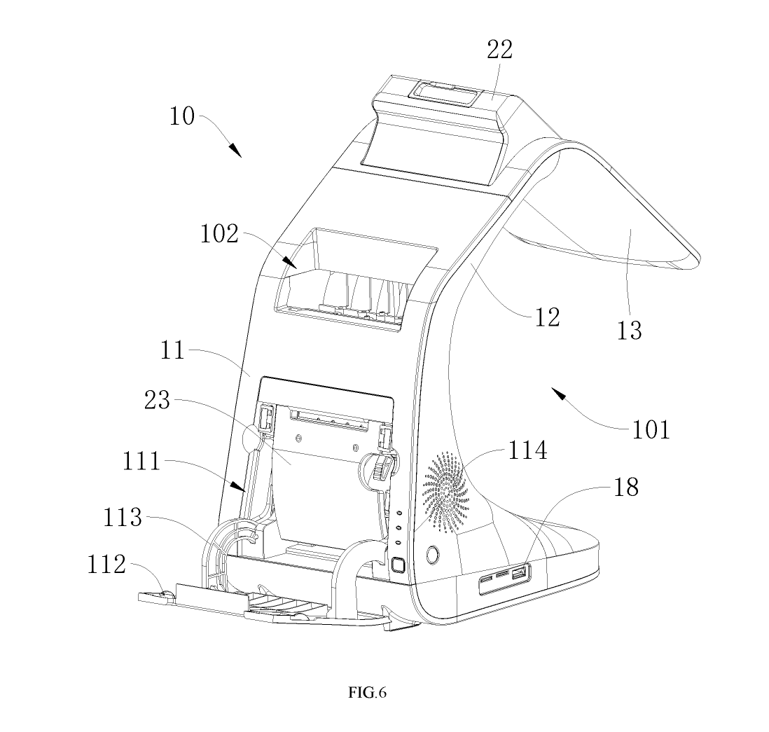

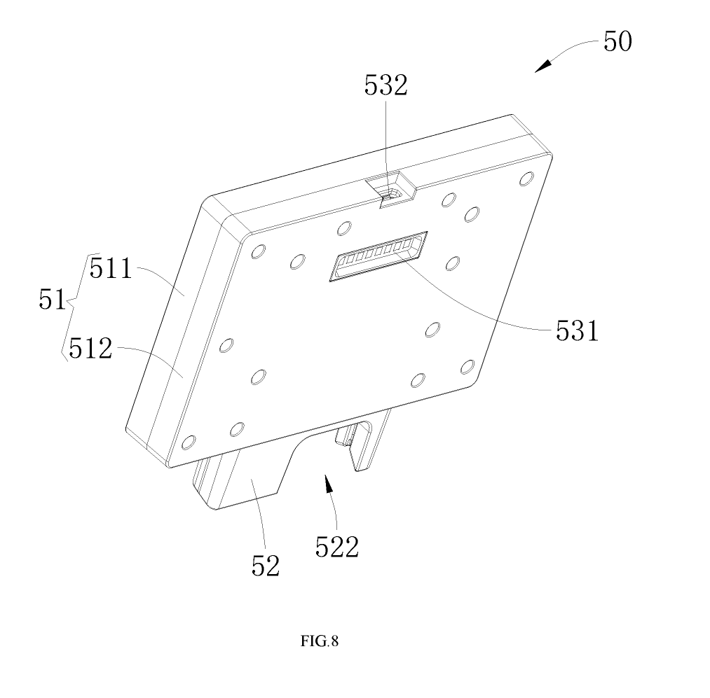

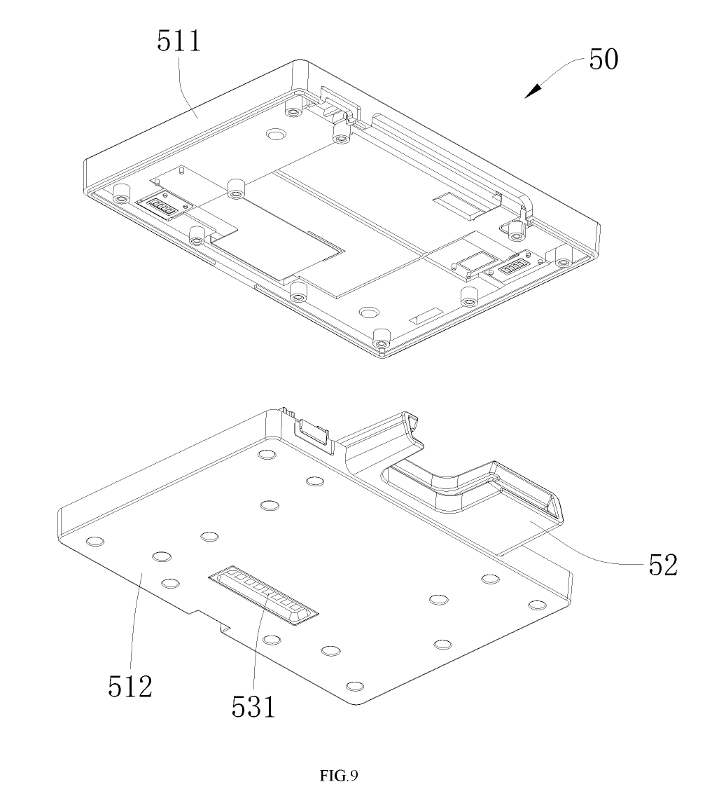

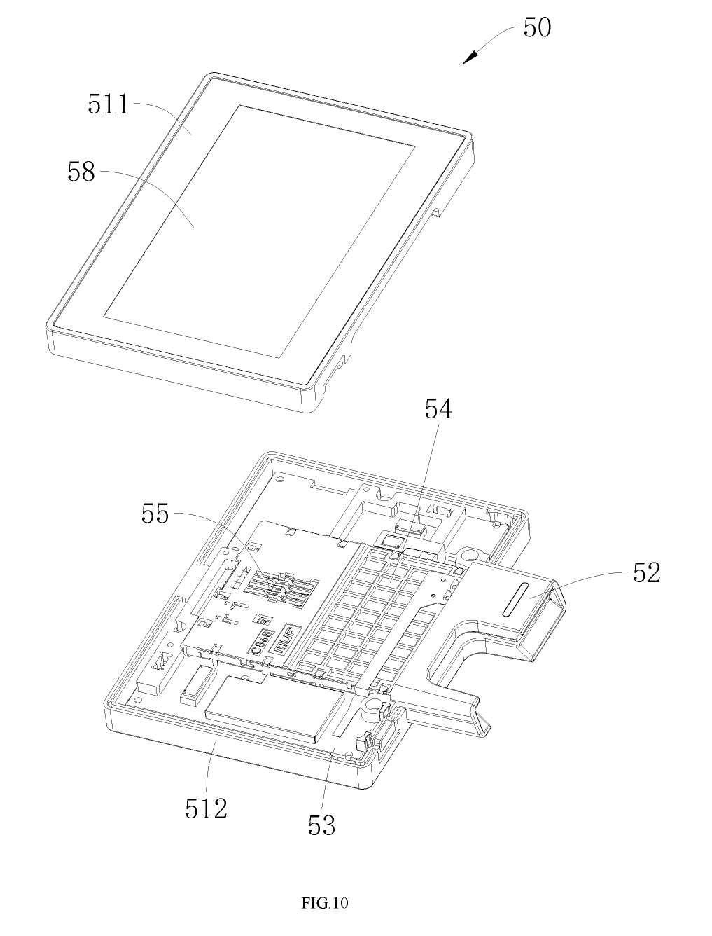

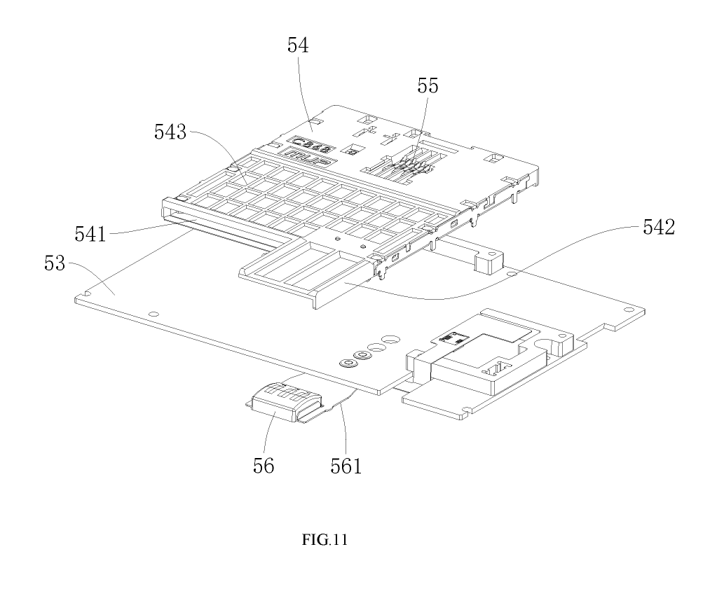

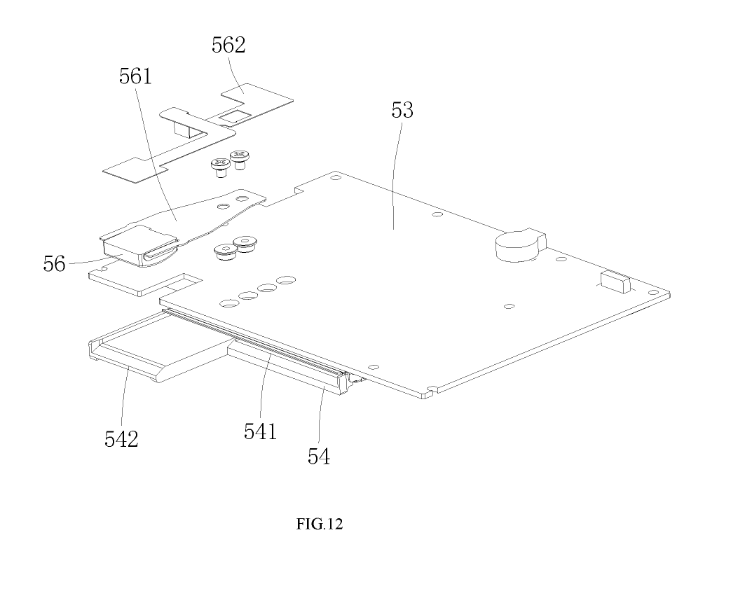

Please refer to FIGS. 1-12, a dual-screen sale terminal 100 provided by the present application is now described as follows. The dual-screen sale terminal 100 comprises: a housing 10, a mainboard (not shown in the figures), a first display 21, and a second display 30. The mainboard is mounted in the housing 10, the first display 21 is electrically connected with the mainboard, and the first display 21 and the second display 30 are mounted on the housing 10. A front side of the housing 10 defines an arc-shaped opening 101 so as to reduce an occupied space, save material, and make the casing 51 have more beautiful appearance. Specifically, the housing 10 comprises: a base 11, a frame 12, and a bracket 13; the frame 12 bends and extends forwardly from an upper end of the base 11, the bracket 13 inclines and extends downwardly from a front end of the frame 12, so that the housing 10 forms the arc-shaped opening 101. The mainboard is mounted in the base 11, the first display 21 is mounted on the bracket 13, and the second display 30 is mounted on the upper end of the base 11. Thus, it is convenient to mount and arrange the first display 21 and the second display 30, thereby reducing the occupied space. The second display 30 is mounted on the upper end of the base 11, the first display 21 is mounted on the bracket 13, and the bracket 13 inclinedly extends downwardly the front end of the frame 12, which facilitates supporting of the first display 21 and is convenient for persons in front of and behind the casing 51 to observe the contents displayed on the first display 21 and the second display 30, furthermore, such a structure enables a center of gravity of the dual-screen sale terminal 100 to be located at a geometry central area, which makes the support of the dual-screen sale terminal 100 be more stable. Further, the base 11 is tapered from bottom to top, and the front end of the base 11 is arc-shaped. More specifically, the base 11 is in a boot-like shape, which makes the base 11 be more stably supported on a table.

Regarding the dual-screen sale terminal 100 provided by the present application, when compared with the prior art, in the present application, the housing 10 is formed by the base 11, the frame 12, and the bracket 13, the arc-shaped opening 101 is formed at the front side of the housing 10, and the first display 21 is mounted at the upper end of the base 11, while the second display 30 is mounted on the bracket 13, which not only ensure that the casing 51 is stably supported on the table, but also is convenient for persons in front of and behind the casing 51 to observe the content displayed on the first display 21 and the second display 30, moreover, the layout of the structure can reduce the occupied space, thus being convenient to be used.

Further, please refer to FIGS. 1, 5-6, as one embodiment of the dual-screen sale terminal 100 provided by the present application, the second display 30 is a smart tablet electronic device, which can be a tablet computer, a smart phone, etc. The use of the tablet computer as the second display 30 is conducive to the mounting and replacement. Specifically, when the tablet computer is used as the second display 30, a hard protective jacket can be provided, the hard protective jacket is fixed on the base 11 and the tablet computer is accommodated in the hard protective jacket, so as to mount and fix the second display 30 conveniently.

Further, please refer to FIGS. 1, 5-6, as one embodiment of the dual-screen sale terminal 100 provided by the present application, the first display 21 and the second display 30 are arranged, both the first display 21 and the second display 30 can be electrically connected with the mainboard, the first display 21 and the second display 30 are simultaneously controlled by a processor in the mainboard, such that the first display 21 and the second display 30 display the same content and receive separate input operation. It should be understood that the first display 21 and the second display 30 can be controlled by the processor of the mainboard to display different content, and to receive different input operation.

Further, please refer to FIGS. 1, 5-6, as one embodiment of the dual-screen sale terminal 100 provided by the present application, when the second display 30 adopts the tablet electronic device, it can be used individually and display content different from the first display 21, and different contents can be input via the first display 21 and the second display 30. It should be understood that when adopting the tablet electronic device, the second display 30 can establish communication connection with the mainboard, and the display of the same contents and separate input operation by the first display 21 and the second display 30 can be realized.

Further, as one embodiment of the dual-screen sale terminal 100 provided by the present application, the second display 30 comprises a display screen body 31 and a support base 32 for supporting the display screen body 31. By arranging the support base 32, it is convenient to support the display screen body 31, moreover, the support base 32 is mounted on the base 11, so that the display screen body 31 can be mounted on the base 11. Further, the support base 32 is pivotally connected to the base 11, so that the inclined angle of the display screen body 31 can be adjusted according to heights of different persons, thereby facilitating users' use.

Further, as one embodiment of the dual-screen sale terminal 100 provided by the present application, the support base 32 comprises a fixed base 33 and a support block 34, the support block 34 is pivotally connected to the fixed base 33, the fixed base 33 is mounted on the base 11, while the display screen body 31 is mounted on the support block 34; and the display screen body 31 is supported by the support block 34, and the support block 34 is pivotally connected to the fixed base 33, such that the support block 34 is rotatable relative to the fixed base 33 so as to further adjust an inclination angle of the display screen body 31.

Further, as one embodiment of the dual-screen sale terminal 100 provided by the present application, the fixed base 33 is U-shaped and the fixed base 33 comprises a bottom plate 331 and two support plates 332, the two support plates 332 are formed by respectively bending two ends of the bottom plate 331. A bottom of the support block 34 defines open slots 341 allowing the two support plates 332 to be inserted therein, the support base 32 further comprises an pivotal axle (not shown in the figures) pivotally connecting the two support plates 332 to the support block 34. The fixed base 33 of such a structure is convenient to be processed and fabricated, and can also be easily mounted and fixed on the base 11. The arrangement of the support block 34 makes the processing thereof convenient; while the arrangement of the open slot 341 on the support block 34 functions in protecting and preventing impurities from entering a rear of the display screen body 31.

Further, as one embodiment of the dual-screen sale terminal 100 provided by the present application, two sides of the support block 34 are obliquely arranged to be V-shaped. The arrangement of the obliquely V-shaped two sides of the support block 34 make the bottom of the support block 34 relatively narrow, which is convenient to be connected to the fixed base 33, furthermore, the fixed base 33 can be fabricated to be relatively small. In addition, a cross section of the support block 34 is triangular-shaped, which can support the display screen body 31 more stably. Further, the support block 34 adopts a shell structure, which is conducive to the mounting of the pivotal axle, so that the two support plates 332 are pivotally connected to the support block 34.

Further, as one embodiment of the dual-screen sale terminal 100 provided by the present application, a rear side of a interface region between the base 11 and the frame 12 defines a mounting recess 102, and the fixed base 33 is mounted to a bottom of the mounting recess 102. By defining the mounting recess 102 on a rear side of the interface region between the base 11 and the frame 12, it is conducive for accommodation of the fixed base 33 and reduction of the occupied space.

Further, as one embodiment of the dual-screen sale terminal 100 provided by the present application, a lower part of the base 11 comprises an accommodation chamber 111, a printer 23 is mounted inside the accommodation chamber, and the printer is electrically connected with the mainboard. The arrangement of the printer 23 facilitates n information in sale. While the arrangement of the accommodation chamber 111 in the lower part of the base 11 and the mounting of the printer 23 in the accommodation chamber 111 can effectively utilize the space within the base 11 and increase the weight of the base 11, such that the base 11 is more stable and therefore can stably support the first display 21 and the second display 30.

Further, as one embodiment of the dual-screen sale terminal 100 provided by the present application, a rear side of the base 11 defines a mounting port at a position corresponding to the printer 23, a cover plate 112 for covering the mounting port is pivotally connected to the base 11. By arranging the mounting port at the rear side of the base 11 and pivotally connecting the cover plate 112 to the base, it is convenient to mount the printer 23, and to replace a paper roll tape after the cover plate 112 is opened. Moreover, this structure can facilitate conveyance of a printed paper band out of the mounting port.

Further, as one embodiment of the dual-screen sale terminal 100 provided by the present application, a lower end of the cover plate 112 is pivotally connected to the base 11. By pivotally connecting the lower end of the cover plate 112 to the base 11, when the cover plate 112 is opened, the cover plate 112 can be supported on the table, which makes the cover plate 112 be more stable, thereby being convenient to replace the paper roll tape.

Further, as one embodiment of the dual-screen sale terminal 100 provided by the present application, two sides of the lower end of the cover plate 112 are respectively connected with arc-shaped strips 113, and free ends of the arc-shaped strips 113 are hinged with the base 11. This structure can increase an angle between the cover plate 112 and the base 11 when the cover plate 112 is opened, moreover, when the cover plate 112 is opened, the cover plate 112 is apart from the base 11, and the cover plate 112 is prevented from obstructing the mounting port, such that the paper roll tape is replaced more conveniently.

Further, two sides of the base 11 respectively define heat dissipation holes 114 for thermal dissipation.

Further, as one embodiment of the dual-screen sale terminal 100 provided by the present application, the base 11 is provided thereon with a data communication interface 18, and the data communication interface 18 is electrically connected with the mainboard. The arrangement of the data communication interface 18 facilitates data communication with other devices. The data communication interface 18 can be a USB interface for connecting with devices such as a U disk. The data communication interface 18 can also adopts a network interface, an HDMI interface, etc.

Further, as one embodiment of the dual-screen sale terminal 100 provided by the present application, a router module is mounted inside the housing 10 and the router module is electrically connected with the mainboard. The arrangement of the router module is conducive to provide the router function and enables the user to perform wireless connection. Further, the data communication interface 18 can be plural, of which, one is the network interface so that the router module is connected to an external network via the network interface. It should be understood that the router module can also be connected to the external network wirelessly. Specifically, the router module is mounted in the base.

Further, please refer to FIG. 1-5, as one embodiment of the dual-screen sale terminal 100 provided by the present application, the dual-screen sale terminal 100 further comprises a card swiping device 50, the card swiping device 50 is mounted on the housing 10, and the card swiping device 50 is electrically connected with the mainboard for facilitating the card swiping for consumption. Further, the card swiping device 50 is mounted at an upper side of the frame 12, enabling the card swiping device 50 be located between the first display 21 and the second display 30, thereby reducing the occupied space thereof.

Further, please refer to FIG. 1-5, as one embodiment of the dual-screen sale terminal 100 provided by the present application, a support 22 for supporting the card swiping machine 50 is mounted in the housing, the support 22 is provided therein with a data plug 222, the card swiping device 50 is provided with a data socket for facilitating electrical connection with the data socket 222, and the arrangement of the support 22 is conducive to the mounting and fixing of the card swiping machine 50.

Further, as one embodiment of the dual-screen sale terminal 100 provide by the present application, the card swiping machine 50 is detachably mounted on the support 22, the support 22 defines therein an accommodation recess 221. By defining the accommodation recess 221 in the support, it is convenient to mount and fix the card swiping device, moreover, it is convenient to detachably mount the card swiping device in the support 22. As the card swiping device 50 is detachably mounted in the support 22, the card swiping device 50 can be detached for swiping cards, so that the use is more convenient.

Further, as one embodiment of the dual-screen sale terminal 100 provided by the present application, the data plug 222 is mounted on the housing 10, a bottom of the support 22 defines an opening for exposing the data plug 222 and allowing the data plug 222 to protrude into the support 22. This structure allows the support 22 and the data plug 222 to be separately mounted on the housing 10, thus being convenient for processing and fabrication. In other embodiments, the data plug 222 can also be provided on the bottom of the support 22. Further, the data plug 222 adopts a structure of telescope insertion pins, so that the card swiping device 50 can be provided thereon with contacts, which is convenient to be connected with as well as detached from the data plug 222.

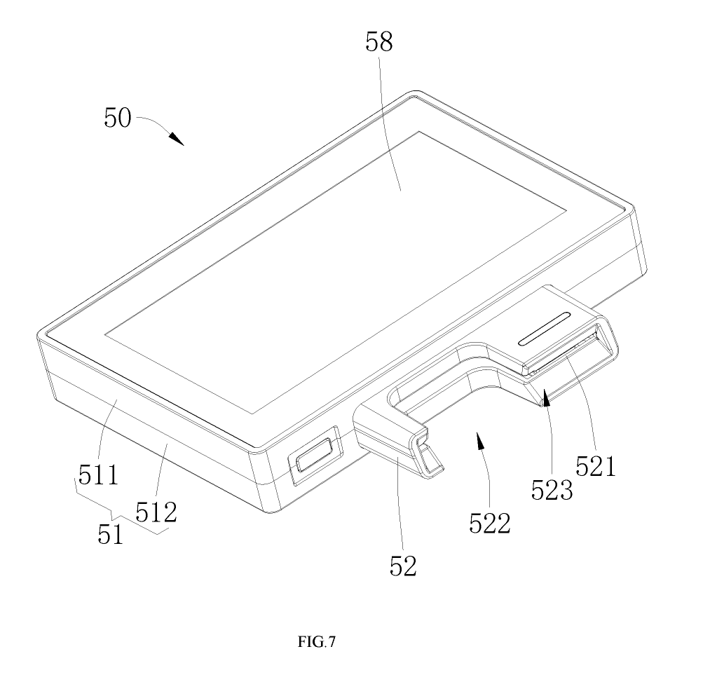

Further, please refer to FIGS. 7-12, as one embodiment of the POS machine 100 provided by the present application, a bottom of the card swiping device 50 is provided with a gold finger 531 connected to the data plug 222. The data plug 222 is mounted in the support 22. Specifically, in this embodiment, the data socket is the gold finger 531. The gold finger 531 is arranged at the bottom of the card swiping device 50, when the card swiping device 50 is mounted on the support 22, the gold finger 531 contacts with the data plug 222, thereby realizing the electric connection between the card swiping device 50 and the mainboard. The card swiping device 50 is used for swiping cards, which enables customers to use cards including credit cards and member cards for payment during consumption.

Further, please refer to FIGS. 7-12, as one embodiment of the POS machine 100 provided by the present application, the card swiping device 50 comprises: a casing 51, a circuit board 53, a magnetic head 56, a card reader 55, and a card support 54. The circuit board 53 is mounted inside the casing 51, the magnetic head 56 is used to read information of magnetic strip cards, the card reader 55 is used to read information of chip cards; the card support 54 is used to position the cards, and the cards can be the credit cards, bankcards, or member cards in the form of the magnetic strip card or the chip card. The card support 54 defines therein a card slot 541 allowing the card to be inserted therein, the card support 54 is mounted inside the casing 51, the magnetic head 56 is electrically connected with the circuit board 53, the card reader 55 is mounted on the card support 54, the magnetic head 56 is disposed on the card support 54, a side of the casing 51 defines a first opening allowing the card to be inserted into the card slot 541, the gold finger 531 is electrically connected with the circuit board 53, a bottom of the casing 51 defines a second opening to expose the gold finger 531. By defining the card slot 541 on the card support 54, it is convenient for the insertion of the card into the card slot 541. By disposing the magnetic head 56 on the card support 54 and by mounting the card reader 55 on the card support 54, when the chip card is inserted into the card slot 541, the information of the chip card can be read by the card reader 55; when the magnetic strip card is inserted into the card slot 541, the information of the magnetic strip card can be read by the magnetic head 56. Thus, the reading structure for the magnetic strip card and the reading structure for the chip card are integrated as a whole, which reduces the occupied space, and the card swiping device 50 can be fabricated to be much smaller; moreover, in use, it is not necessary to distinguish whether the card is a magnetic strip card or a chip card, making the use convenient.

Further, please refer to FIGS. 7-12, as one embodiment of the POS machine 100 provided by the present application, the card swiping device 50 further comprises a positioning head 52 for positioning the card. The positioning head 52 defines therein with a slit 521 for guiding and positioning the card, and a rear end of the positioning head 52 is fixed in the first opening. The arrangement of the positioning head 52 can function in positioning when the card is inserted into the card slot 541 of the card support 54, thereby facilitating use.

Further, as one embodiment of the dual-screen sale terminal 100 provided by the present application, the card support 54 extends from a front section of the card slot 541 to form a support plate 542, and the magnetic head 56 is disposed on the support plate 542. Because it requires relatively long stroke when reading the information of the magnetic strip card, while the support plate 542 is arranged on the card support 54, and the support plate 542 is disposed on the magnetic head 56, the card support 54 can be designed to be relatively small, and the casing 51 can therefore be designed to be relatively small, thus reducing the volume of the card swiping device 50.

Further, as one embodiment of the dual-screen sale terminal 100 provided by the present application, the magnetic head 56 and the support plate 542 extend into the positioning head 52, and the magnetic head 56 is located at one side of the positioning head. Such a structure allows the magnetic head 56 and the support plate 542 to extend into the positioning head 52, as the positioning head 52 is mounted on the casing, the volume of the casing 51 can be further minimized, so that the card swiping device 50 is fabricated to have a much smaller volume.

Further, as one embodiment of the dual-screen sale terminal 100 provided by the present application, the positioning head 52 defines a notch 522, and the notch 522 and the magnetic head 56 are respectively located at two sides of the positioning head 52. By arranging the notch 522 on the positioning head 52, it is convenient to insert a card into the positioning head 52; moreover, when the card is inserted into the card slot 541 of the card support 54, such a structure facilitates clamping the card at the notch 522 and further facilitates taking the card out.

Further, as one embodiment of the dual-screen sale terminal 100 provided by the present application, a front end of the positioning head 52 is provided with a guide slot 523, of which a width gradually reduces from the front to rear. Such a structure is conducive to insert the card into the slit 521 of the positioning head 52, and further guide the card into the card slot 541 of the card support 54.

Further, as one embodiment of the dual-screen sale terminal 100 provided by the present application, the card swiping device 50 further comprises an resilient piece 561 for supporting the magnetic head 56, one end of the resilient piece 561 is fixed on the circuit board 53, and the magnetic head 56 is mounted on the other end of the resilient piece. By using the resilient piece 561 to support the magnetic head 56, when the card being inserted, the magnetic head 56 can be better attached to the card so as to read the information of the magnetic strip card.

Further, as one embodiment of the dual-screen sale terminal 100 provided by the present application, the card swiping device 50 further comprises a flexible circuit board 562 electrically connecting with the magnetic head 56 and the circuit board 53. The use of the flexible circuit board 562 to connect with the magnetic head 56 and the circuit board 53 is conducive to the electrical connection of the magnetic head 56 and the circuit board 53, as well as the mounting and the layout of the magnetic head 56.

Further, as one embodiment of the dual-screen sale terminal 100 provided by the present application, the casing 51 comprises a bottom cover 512 and an upper cover 511 arranged onto the bottom cover 512, the card support 54 is mounted on the circuit board 53, and the circuit board 53 is fixed on the bottom cover 512. The casing 51 is formed by using the bottom cover 512 and the upper cover 511, thereby being convenient to be processed and fabricated, meanwhile it is also convenient to mount the circuit board 53 and the card support 54. Moreover, by mounting the card support 54 on the circuit board 53 and fixing the circuit board 53 on the bottom cover 512, the casing 51 can be fabricated to have a relatively small thickness, thereby being convenient to be hold and used.

Further, as one embodiment of the dual-screen sale terminal 100 provided by the present application, the card swiping device 50 further comprises a display screen 58, the display screen 58 is mounted on a top surface of the casing 51, and the display screen 58 is electrically connected with the circuit board 53. The arrangement of the display screen 58 on the casing 51 is conducive to display of the consumption information when swiping the card.

Further, the display screen 58 is a touch screen. Thus, when the card swiping device 50 is used for swiping card for consumption, it enables users to sign their names and input the consumption information.

Further, a top of the casing 51 defines a concave accommodation portion (not shown in the figures) configured to match with and mount the display screen 58. The arrangement of the concave accommodation portion is conducive to the mounting of the display screen 58, and at the same time can provide the function of protecting lateral sides of the display screen 58.

Further, as one embodiment of the dual-screen sale terminal 100 provided by the present application, the card swiping device 50 further comprises a wireless module (not shown in the figures) for wireless communication, the wireless module is electrically connected with the circuit board 53. The wireless module is arranged, so that it is convenient to communicate when swiping the card.

Further, as one embodiment of the dual-screen sale terminal 100 provided by the present application, the card support 54 is provided thereon with a plurality of ribs 543. By arranging the ribs 543 on the card support 54, the strength of the card support 54 can be enhanced.

Further, as one embodiment of the dual-screen sale terminal 100 provided by the present application, the card swiping device 50 further comprises a data interface 532 that is electrically connected with the circuit board, a rear end of the casing 51 defines a third opening (not shown in the figures), the data interface 532 is mounted in a position corresponding to the third opening. By arranging the data interface 532, it is convenient for the card swiping device 50 to establish data communication with other electronic devices.

### Embodiment 2

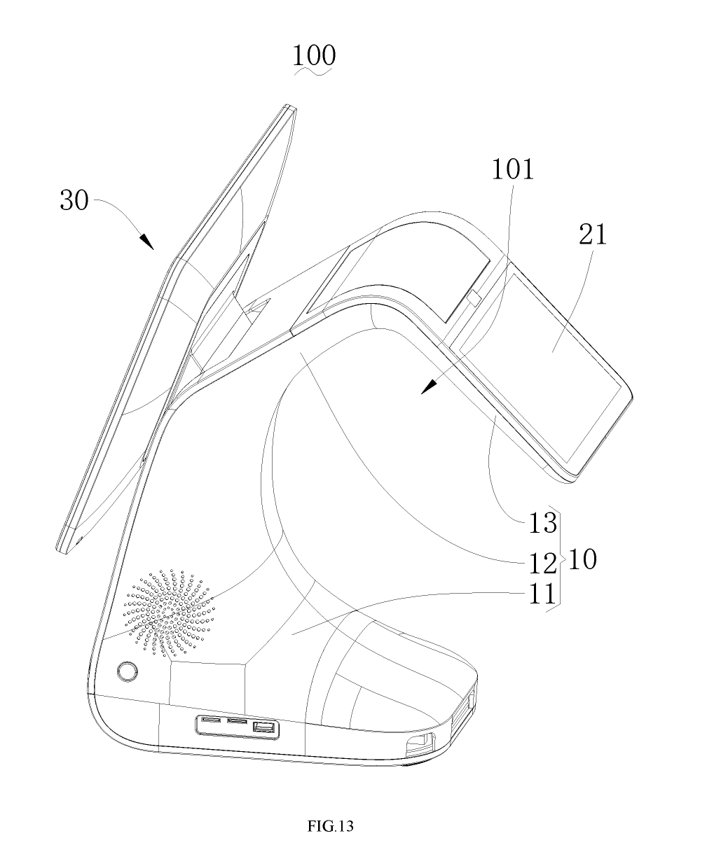

Please refer to FIG. 13, the dual-screen sale terminal 100 of this embodiment differs from the dual-screen sale terminal 100 of the embodiment 1 in that: please also refer to FIG. 1, in this embodiment, neither card swiping machine 50 nor support 22 is mounted on the bracket 13. This dual-screen sale terminal 100 has relatively simpler structure and lower cost.

Other structures of the dual-screen sale terminal 100 of this embodiment are similar to other structures of the dual-screen sale terminal 100 of example 2 and will not be repeated here.

The aforementioned embodiments are only preferred embodiments of the present application, and are not intended to limit the present application. Any modification, equivalent replacement, improvement, and so on, which are made within the spirit and the principle of the present application, should be included in the protection scope of the present application.

1. A dual-screen sale terminal, comprising a housing and a mainboard mounted inside the housing; wherein the dual-screen sale terminal further comprises a first display and a second display that are mounted at the housing; the first display is electrically connected with the mainboard, a front side of the housing defines an arc-shaped opening, and the housing comprises a base, a frame bending and extending forwardly from an upper end of the base, and a bracket inclinedly extending downwardly from a front end of the frame; and the main board is mounted in the base, the first display is mounted on the bracket, and the second display is mounted on the upper end of the base.

2. The dual-screen sale terminal of claim 1, wherein the second display is a smart tablet electronic device.

3. The dual-screen sale terminal of claim 1, wherein the second display comprises a display screen body and a support base supporting the display screen body.

4. The dual-screen sale terminal of claim 3, wherein the support base comprises a fixed base mounted on the base and a support block supporting the display screen body, and the support block is pivotally connected to the fixed base.

5. The dual-screen sale terminal of claim 4, wherein the fixed base is U-shaped, the fixed base comprises a bottom plate and two support plates formed by respectively bending two ends of the bottom plate, a bottom of the support block defines open slots allowing the two support plates to be inserted therein, and the support base further comprises an pivotal axle allowing the two support plates to be pivotally connected to the support block.

6. The dual-screen sale terminal of claim 5, wherein a rear side of a interface region between the base and the frame defines a mounting recess, and the fixed base is mounted to a bottom of the mounting recess.

7. The dual-screen sale terminal of claim 1, wherein a lower part of the base comprises an accommodation chamber, a printer is mounted inside the accommodation chamber, and the printer is electrically connected with the mainboard.

8. The dual-screen sale terminal of claim 1, wherein the dual-screen sale terminal further comprises a card swiping device, the card swiping device is mounted at an upper side of the frame, and the card swiping device is electrically connected with the mainboard.

9. The dual-screen sale terminal of claim 8, further comprising a support supporting the card swiping machine, wherein the support is mounted at a connection portion between the frame and the bracket, a data insertion pin configured to connect with the card swiping machine is mounted in the support, the data insertion pin is electrically connected with the mainboard, and a bottom of the card swiping device is provided with a gold finger configured to connect with the data insertion pin.

10. The dual-screen sale terminal of claim 9, wherein, the card swiping machine comprises: a casing, a circuit board mounted inside the casing, a magnetic head configured to read information of magnetic strip cards, a card reader configured to read information of chip cards, and a card support configured to locate cards; the card support defines therein a card slot allowing the card to be inserted therein, the card support is mounted inside the casing, the magnetic head is electrically connected with the circuit board, the card reader is mounted on the card support, the magnetic head is disposed on the card support, a side of the casing defines a first opening allowing the card to be inserted into the card slot, the gold finger is electrically connected with the circuit board, and a bottom of the casing defines a second opening exposing the gold finger.

11. The dual-screen sale terminal of claim 6, wherein a lower part of the base comprises an accommodation chamber, a printer is mounted inside the accommodation chamber, and the printer is electrically connected with the mainboard.

12. The dual-screen sale terminal of claim 6, wherein the dual-screen sale terminal further comprises a card swiping device, the card swiping device is mounted at an upper side of the frame, and the card swiping device is electrically connected with the mainboard.

13. The dual-screen sale terminal of claim 12, further comprising a support supporting the card swiping machine, wherein the support is mounted at a connection portion between the frame and the bracket, a data insertion pin configured to connect with the card swiping machine is mounted in the support, the data insertion pin is electrically connected with the mainboard, and a bottom of the card swiping device is provided with a gold finger configured to connect with the data insertion pin.

14. The dual-screen sale terminal of claim 13, wherein, the card swiping machine comprises: a casing, a circuit board mounted inside the casing, a magnetic head configured to read information of magnetic strip cards, a card reader configured to read information of chip cards, and a card support configured to locate cards; the card support defines therein a card slot allowing the card to be inserted therein, the card support is mounted inside the casing, the magnetic head is electrically connected with the circuit board, the card reader is mounted on the card support, the magnetic head is disposed on the card support, a side of the casing defines a first opening allowing the card to be inserted into the card slot, the gold finger is electrically connected with the circuit board, and a bottom of the casing defines a second opening exposing the gold finger.

15. The dual-screen sale terminal of claim 2, wherein a lower part of the base comprises an accommodation chamber, a printer is mounted inside the accommodation chamber, and the printer is electrically connected with the mainboard.

16. The dual-screen sale terminal of claim 2, wherein the dual-screen sale terminal further comprises a card swiping device, the card swiping device is mounted at an upper side of the frame, and the card swiping device is electrically connected with the mainboard.

17. The dual-screen sale terminal of claim 16, further comprising a support supporting the card swiping machine, wherein the support is mounted at a connection portion between the frame and the bracket, a data insertion pin configured to connect with the card swiping machine is mounted in the support, the data insertion pin is electrically connected with the mainboard, and a bottom of the card swiping device is provided with a gold finger configured to connect with the data insertion pin.

18. The dual-screen sale terminal of claim 17, wherein, the card swiping machine comprises: a casing, a circuit board mounted inside the casing, a magnetic head configured to read information of magnetic strip cards, a card reader configured to read information of chip cards, and a card support configured to locate cards; the card support defines therein a card slot allowing the card to be inserted therein, the card support is mounted inside the casing, the magnetic head is electrically connected with the circuit board, the card reader is mounted on the card support, the magnetic head is disposed on the card support, a side of the casing defines a first opening allowing the card to be inserted into the card slot, the gold finger is electrically connected with the circuit board, and a bottom of the casing defines a second opening exposing the gold finger.
